(19) United States
(12) Patent Application Publication
(10) Pub. No.: US 2026/0133340 A1
(43) Pub. Date: May 14, 2026

(54) METHOD AND SYSTEM FOR DETERMINING STREAMLINES IN A RESERVOIR GEOLOGICAL FORMATION BY DUAL FRONT PROPAGATION

(71) Applicant: TotalEnergies OneTech, Courbevoie (FR)

(72) Inventors: Pierre Thore, Pau (FR); Marion Juilla, Pau (FR); Antoine Michel Lucas, Pau (FR)

(21) Appl. No.: 19/119,245

(22) PCT Filed: Oct. 11, 2022
(86) PCT No.: PCT/IB2022/000580

§ 371 Date: Apr. 8, 2025

(51) Int. Cl. G01V 20/00

(52) U.S. Cl. CPC G01V 20/00

(57) ABSTRACT

A computer implemented method for determining streamlines in a reservoir geological formation, based on a reservoir grid composed of cells, includes front-propagating from a source cell of the reservoir grid to determine front propagation paths originating from the source cell, front-propagating from a target cell of the reservoir grid to determine front propagation paths originating from the target cell, and determining a contact set based on the front propagation paths, and, for at least one contact cell of the contact set: determining a partial streamline by back-propagating from said at least one contact cell up to the source cell, determining a partial streamline by back-propagating from said at least one contact cell up to the target cell, and determining a streamline of the reservoir geological formation by combining the partial streamlines. Hydrocarbons are recovered from the reservoir geological formation using the determined streamline.

### BACKGROUND

### Technical Field

This disclosure relates to the field of reservoir geological formations modeling and exploitation and relates more particularly to a method and system for determining streamlines between a source and a target in a reservoir geological formation, based on a reservoir grid representing said reservoir geological formation.

### Description of the Related Art

In the field of hydrocarbon (oil, natural gas, shale gas, etc.) recovery from an underground reservoir geological formation, it is important to be able to describe the connectivities (e.g., between an injection well and a production well) and the heterogeneities inside the reservoir geological formation. This is also important in the field of carbon capture utilization and storage (CCUS).

In order to evaluate the connectivities and the heterogeneities, it is known to establish a simulation model of said reservoir geological formation, which is used to perform fluid flow simulations. In order to facilitate the interpretation of the connectivities, it is known to use the fluid flow simulations to compute streamlines, i.e., field lines which are orthogonal to the pressure field (i.e., tangent to the velocity vector field at every point), between a source (e.g., an injection well) and a target (e.g., a production well). Such streamlines highlight the preferred fluid flow paths in the reservoir geological formation along which it is possible to compute fluid flows by using Darcy's law. However, such fluid flow simulations are computationally demanding and time consuming.

It has been proposed in PCT publication WO 2020/254851 A1 to compute a skeleton of a reservoir grid.

The reservoir grid based on which is computed the skeleton may be, e.g., a simulation grid underlying the above-mentioned simulation model. The simulation grid represents the 3D volume of the underground reservoir geological formation as a 3D grid of cells, each cell corresponding to a volume of the 3D grid which may be substantially cubic or have a more complex shape. Each cell of the simulation grid is mapped to a corresponding portion of the reservoir geological formation. Each cell of the simulation grid is associated to values of geological properties of the corresponding portion of the reservoir geological formation. The geological properties may be, e.g., the facies (geological index), the porosity, the permeability, etc.

The reservoir grid based on which is computed the skeleton may also be, e.g., a 3D or 4D seismic image representing all or part of the reservoir geological formation. In such a case, the cells correspond to voxels representing respective portions of the reservoir geological formation, and each cell is associated to values of geophysical properties of the corresponding portion of the reservoir geological formation, obtained via seismic measurements carried out on the reservoir geological formation. The geophysical properties may be, e.g., the seismic wave velocity change (4D), the acoustic impedance, the rock density, etc.

The skeleton computed in WO 2020/254851 A1 describes the topology (i.e., the connectivities) underlying the values of the geological and/or geophysical properties of the reservoir grid. This solution has proven to be very effective and less computationally demanding than simulation model-based fluid flow simulations. However, contrary to the streamlines computed by using the simulation model, which are constrained by the pressure field (and which therefore converge naturally towards, e.g., a production well), a skeleton corresponds to a graph extending from a source (e.g., an injection well) which cannot be constrained as such to converge towards a predetermined target, even though the skeleton highlights preferred fluid flow paths inside the reservoir geological formation.

### BRIEF SUMMARY

The present disclosure aims at improving the situation. In particular, the present disclosure aims at overcoming at least some of the limitations of the prior art discussed above, by proposing a solution for determining streamlines between a source and a target in a reservoir geological formation in a computationally effective manner.

According to a first aspect, the present disclosure relates to a computer implemented method for determining streamlines between a source and a target in a reservoir geological formation, based on a reservoir grid corresponding to a 3D grid of cells wherein each cell represents a respective portion of the reservoir geological formation, wherein said method comprises:
front-propagating from a source cell of the reservoir grid, which corresponds to the source in the reservoir geological formation, to determine front propagation paths originating from the source cell,
front-propagating from a target cell of the reservoir grid, which corresponds to the target in the reservoir geological formation, to determine front propagation paths originating from the target cell,
determining a contact set which is composed of contact cells of the reservoir grid at which the front propagation paths originating from the source cell meet the front propagation paths originating from the target cell,
and, for at least one contact cell of the contact set:
   determining a partial streamline by back-propagating along the front-propagation paths originating from the source cell, from said at least one contact cell up to the source cell,
   determining a partial streamline by back-propagating along the front-propagation paths originating from the target cell, from said at least one contact cell up to the target cell,
   determining a streamline of the reservoir geological formation by combining the partial streamlines originating from respectively the source cell and the target cell which reach said at least one contact cell.

Hence, as in WO 2020/254851 A1, the proposed solution performs a front-propagation in order to determine front propagation paths in the reservoir grid. However, two different front-propagations are carried out:
one front-propagation originates from a source cell which corresponds to a predetermined source of the reservoir geological formation (e.g., an injection well),
the other front-propagation originates from a target cell (different from the source cell) which corresponds to a predetermined target of the reservoir geological formation (e.g., a production well).

The front propagation from the source cell propagates a source front which progressively extends away from the source cell. Similarly, the front propagation from the target cell propagates a target front which progressively extends away from the target cell. The cells at which the source front and the target front meet correspond to contact cells and are collectively referred to as contact set.

Hence, a contact cell corresponds to a cell that belongs to both a front propagation path originating from the source cell and to a front propagation path originating from the target cell. Each front-propagation path is typically such that a visited cell may have a parent (or father) cell which corresponds to a cell which is upstream the visited cell according to the front propagation path. The front-propagation implements a front-propagation algorithm that stores for each visited cell an indication of which cell is its immediate parent cell. Hence, any contact cell may be traced back (by back-propagating along the front propagation paths) to both the source cell and the target cell, thereby determining a first partial streamline between the source cell and the contact cell and a second partial streamline between the contact cell and the target cell. A streamline extending from the source cell to the target cell may therefore be obtained by merging these partial streamlines at the contact cell.

In specific embodiments, the streamline determination method can further comprise one or more of the following optional features, considered either alone or in any technically possible combination.

In specific embodiments, the front-propagating from the source cell and the front-propagating from the target cell are performed by iteratively propagating a source front and a target front, respectively, wherein each iteration comprises propagating only one among the source front and the target front, by:
selecting one cell among the cells of the source front and the cells of the target front, and
propagating only the front, among the source front and the target front, which comprises the selected cell.

In specific embodiments, the streamline determination method comprises determining an accessibility attribute value for each cell of the source front and of the target front, and the selected cell corresponds to the cell that is, according to the determined accessibility attribute values, the easiest to access from the source cell and the target cell.

In specific embodiments, the accessibility attribute corresponds to a time of flight.

In specific embodiments, the accessibility attribute corresponds to a cumulated (3D or 4D) geophysical property.

In specific embodiments, a contact cell corresponds to a cell, of one among the source front and the target front, that is reached when front-propagating from a selected cell of the other one among the source front and the target front.

In specific embodiments, front-propagating is performed by using a fast marching algorithm.

In specific embodiments, the streamline determination method comprises determining a contact surface based on the contact set.

In specific embodiments, the streamline determination method comprises evaluating a smoothness of the contact surface.

In specific embodiments, the smoothness of the contact surface is evaluated by comparing said contact surface with a reference surface.

In specific embodiments, the reference surface is determined based on positions of the contact cells.

In specific embodiments, the smoothness of the contact surface is evaluated by applying a frequency transform to the contact surface, thereby obtaining a frequency-domain contact surface, and by analyzing the frequency-domain contact surface.

According to a second aspect, the present disclosure relates to a computer program product stored on a non-transitory computer-readable medium comprising instructions which, when executed by at least one processor, configure said at least one processor to carry out a streamline determination method according to any one of the embodiments of the present disclosure.

According to a third aspect, the present disclosure relates to a non-transitory computer-readable storage medium comprising instructions which, when executed by at least one processor, configure said at least one processor to carry out a streamline determination method according to any one of the embodiments of the present disclosure.

According to a fourth aspect, the present disclosure relates to a computer system for analyzing a reservoir geological formation by using a reservoir grid, said computer system comprising at least one processor and at least one memory, said at least one processor being configured to carry out a streamline determination method according to any one of the embodiments of the present disclosure.

### BRIEF DESCRIPTION OF THE SEVERAL VIEWS OF THE DRAWINGS

The disclosure will be better understood upon reading the following description, given as an example that is in no way limiting, and made in reference to the figures which show:

FIG. 1 is a flow chart illustrating the main steps of a method for determining streamlines between a source and a target in a reservoir geological formation;

FIG. 2 is a schematic representation of examples of front-propagations from a source cell and a target cell;

FIG. 3 is a flow chart illustrating the main steps of an exemplary embodiment of the streamline determination method;

FIG. 4 is a flow chart illustrating the main steps of another exemplary embodiment of the streamline determination method.

In these figures, references identical from one figure to another designate identical or analogous elements. For reasons of clarity, the elements shown are not to scale, unless explicitly stated otherwise.

Also, the order of steps represented in these figures is provided only for illustration purposes and is not meant to limit the present disclosure which may be applied with the same steps executed in a different order.

### DETAILED DESCRIPTION

As discussed above, the present disclosure relates inter alia to a method 10 for determining streamlines between a source and a target in a reservoir geological formation by using a reservoir grid. For instance, the streamline determination method 10 may be used for hydrocarbon (oil, natural gas, shale gas, etc.) recovery from the reservoir geological formation and/or for carbon dioxide storage in said reservoir geological formation. The streamline determination method 10 may be used for any type of source(s) and target(s). In the following description, we consider in a non-limitative manner that the source corresponds to an injection well while the target corresponds to a production well, both drilled into the reservoir geological formation.

The streamline determination method 10 is carried out by a computer system (not represented in the figures). In preferred embodiments, the computer system comprises one or more processors and one or more memories. The one or more processors may include for instance a central processing unit (CPU), a graphical processing unit (GPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors in order to implement all or part of the steps of the streamline determination method 10.

The streamline determination method 10 analyzes the reservoir geological formation based on a reservoir grid which models the reservoir geological formation. As indicated above, the reservoir grid represents the 3D volume of the underground reservoir geological formation as a 3D grid of cells, each cell corresponding to a volume of the 3D grid which may be substantially cubic or have a more complex shape. Each cell of the reservoir grid is mapped to a corresponding portion of the reservoir geological formation.

Each cell of the reservoir grid is for instance associated to values of geological properties of the corresponding portion of the reservoir geological formation. The geological properties may be, e.g., the facies (geological index), the porosity, the permeability, etc. In such a case, the reservoir grid may correspond to a simulation grid used in a simulation model which may be used to simulate hydrocarbon extraction from the reservoir geological formation and/or carbon dioxide storage in the reservoir geological formation.

However, in other examples, the reservoir grid may also be any 3D or 4D seismic image representing all or part of the reservoir geological formation. In such a case, the cells correspond to voxels representing respective portions of the reservoir geological formation, and each cell is associated to values of geophysical properties of the corresponding portion of the reservoir geological formation obtained via seismic measurements carried out on the reservoir geological formation. The geophysical properties may be, e.g., the seismic wave velocity change (4D), the acoustic impedance, the rock density, etc. Among other applications, the streamlines determined based on a reservoir grid which corresponds to such a 3D or 4D seismic image may be used to establish/update a simulation grid of a simulation model of the reservoir geological formation.

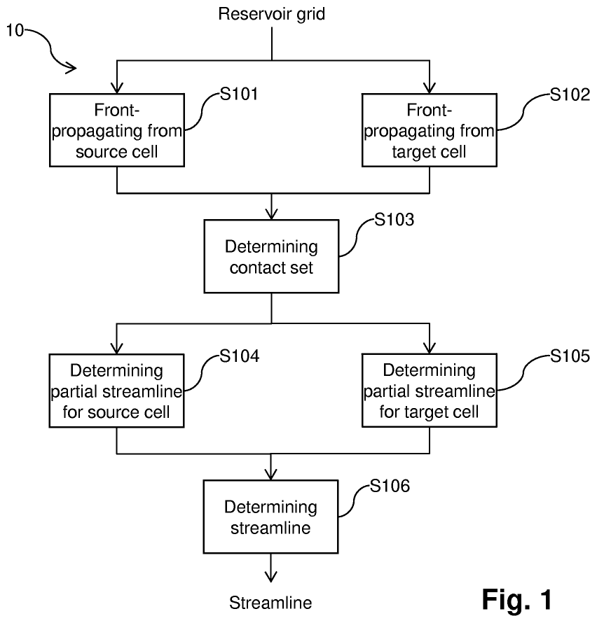

FIG. 1 represents schematically the main steps of an exemplary embodiment of a method 10 for determining streamlines between the source and the target in the reservoir geological formation.

As illustrated by FIG. 1, the streamline determination method 10 comprises a step S101 of front-propagating from a source cell 20 to determine front-propagation paths originating from the source cell. Also, the streamline determination method 10 comprises a step S102 of front-propagating from a target cell 21 to determine front-propagation paths originating from the target cell.

The source cell 20 is a cell of the reservoir grid which corresponds to the source in the reservoir geological formation. If the source is an injection well, then it comprises at least one output where a fluid injected by the injection well exits the interior of the injection well towards the exterior of the injection well, into the reservoir geological formation. The source cell 20 may therefore correspond in this case to the portion of the reservoir geological formation where the output of the injection well (source) is located. It should be noted that an injection well may comprise a plurality of such outputs (e.g., a plurality of well perforations) located in different portions of the reservoir geological formation. It is therefore possible to consider a plurality of source cells 20 for a same source, and therefore to front-propagate from a plurality of source cells 20. In the sequel, we consider in a non-limitative manner that the front-propagating step S101 is carried out from a single source cell 20 of the reservoir grid.

The target cell 21 is a cell of the reservoir grid which corresponds to the target in the reservoir geological formation. The target cell 21 is different from the source cell 20. If the target is a production well, then it comprises at least one input where a fluid recovered by the production well enters the interior of the production well from the exterior of the production well, inside the reservoir geological formation. The target cell 21 may therefore correspond in this case to the portion of the reservoir geological formation where the input of the production well (target) is located. It should be noted that a production well may comprise a plurality of such inputs (e.g., a plurality of well perforations) located in different portions of the reservoir geological formation. It is therefore possible to consider a plurality of target cells 21 for a same target, and therefore to front-propagate from a plurality of target cells 21. In the sequel, we consider in a non-limitative manner that the front-propagating step S102 is carried out from a single target cell 21 of the reservoir grid.

Hence, the streamline determination method 10 performs at least two different front-propagations, i.e., a front-propagation which originates from the source cell 20 and a front-propagation which originates from the target cell 21.

The front-propagations from the source cell 20 and the target cell 21 may use, e.g., a fast marching algorithm, a best neighbor propagation algorithm, etc. For instance, the front-propagation comprises iteratively expanding a front of cells. The front expanding from the source cell 20 is referred to as “source front” and the front expanding from the target cell 21 is referred to as “target front.”

Each front-propagation results in visited cells. By “visited cell,” it is meant any cell of the reservoir grid which has been part of a front (i.e., the source front or the target front) at an iteration of the front-propagations. The visited cells may be all the cells of the reservoir grid or at least a part of the cells of the reservoir grid, e.g., depending on whether the front-propagations have a stopping criterion or not and/or depending on the geological/geophysical property values.

The front-propagations store a parent cell for each visited cell. The parent cell of a visited cell corresponds to the cell from which the front-propagation has resulted in visiting the considered visited cell. Hence, using this property (parent cell) it is easy to retrieve the paths, referred herein as front propagation paths:
from the source cell 20 to any visited cell reached by front-propagating from the source cell, and vice versa, and
from the target cell 21 to any visited cell reached by front-propagating from the target cell, and vice versa.

At a given iteration of the front-propagations, the source front is composed of the visited cells, along the front-propagation paths originating from the source cell 20, which are not parent cells of other cells (i.e., the last visited cells of the front propagation paths at the considered iteration). Similarly, the target front is composed of the visited cells, along the front-propagation paths originating from the target cell 21, which are not parent cells of other cells (i.e., the last visited cells of the front propagation paths at the considered iteration).

As illustrated by FIG. 1, the streamline determination method 10 comprises a step S103 of determining a contact set 220 which is composed of contact cells of the reservoir grid at which the front propagation paths originating from the source cell 20 meet the front propagation paths originating from the target cell 21. Indeed, the front propagation from the source cell 20 propagates the source front which progressively extends away from the source cell 20. Similarly, the front propagation from the target cell 21 propagates the target front which progressively extends away from the target cell 21. The cells at which the source front and the target front meet correspond to contact cells and are collectively referred to as contact set. Hence, a contact cell corresponds to a cell that belongs to both a front propagation path originating from the source cell 20 and to a front propagation path originating from the target cell 21.

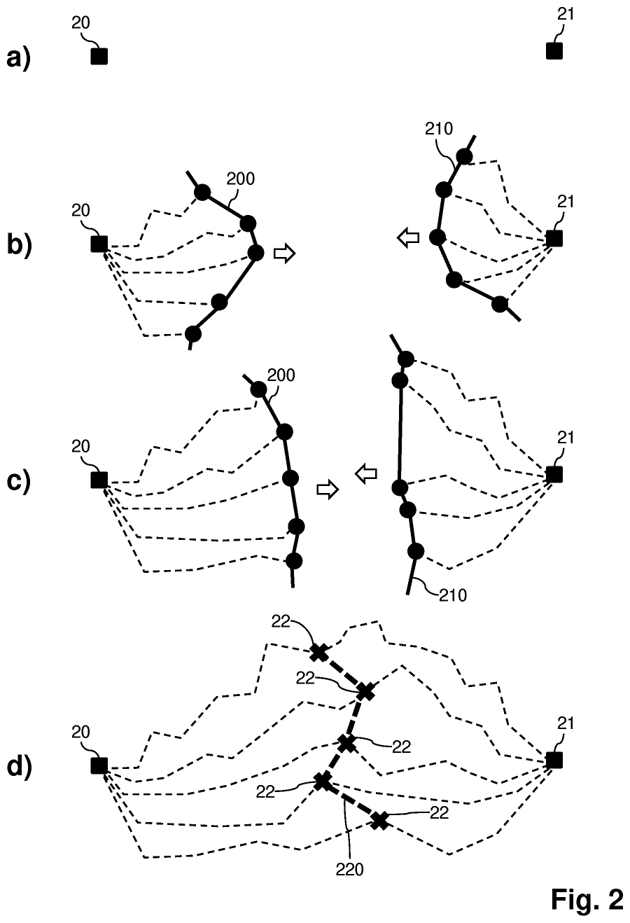

FIG. 2 represents schematically examples of front-propagations paths. It is emphasized that, for clarity purposes, the front propagation paths are represented as progressing in a 2D plane and the fronts are represented as 2D curves. Of course, in practice, the front propagation paths and the fronts may have complex 3D shapes. Also, for clarity purposes, not all front propagation paths are represented. Of course, in practice, there are typically many more front propagation paths, including front-propagation paths which propagate from the source cell 20 (resp. the target cell 21) towards the side opposed to the target cell 21 (resp. the source cell 20).
Part a) of FIG. 2 represents schematically the source cell 20 and the target cell 21 inside the reservoir grid, before performing both front-propagations.
Part b) of FIG. 2 represents schematically front propagation paths originating from the source cell 20 and front propagation paths originating from the target cell 21, and the corresponding source front 200 and target front 210. More specifically, in part b), the front propagations are still on-going, such that the source front 200 and the target front 210 are still expanding away from the source cell 20 and from the target cell 21.
Part c) of FIG. 2 represents schematically the same front propagation paths as in part b), but at a later stage of the front propagations. The front propagations are still on-going and, compared to part b) of FIG. 2, the source front 200 and the target front 210 have expanded farther from the source cell 20 and from the target cell 21.
Part d) of FIG. 2 represents schematically the same front propagation paths as in part c), but at a later stage of the front propagations. As illustrated by part d) of FIG. 2, the source front 200 and the target front 210 have expanded farther from the source cell 20 and from the target cell 21, such that said source front 200 and said target front 210 have met together. The cells at which the source front 200 and the target front 210 meet correspond to contact cells 22 and the contact set 220 corresponds to the collection of contact cells 22.

A contact cell 22 corresponds therefore to a cell that belongs to both a front propagation path originating from the source cell 20 and to a front propagation path originating from the target cell 21. Hence, a contact cell 22 is on a path between the source cell 20 and the target cell 21.

The streamline determination method 10 may therefore determine a streamline for each contact cell 22 of interest by merging the front-propagation paths that meet at the considered contact cell 22. As illustrated by FIG. 1, the streamline determination method 10 comprises, for a contact cell 22 of interest:
a step S104 of determining a first partial streamline by back-propagating along the front-propagation paths originating from the source cell 20, from the considered contact cell 22 up to the source cell 20, and
a step S105 of determining a second partial streamline by back-propagating along the front-propagation paths originating from the target cell 21, from the considered contact cell 22 up to the target cell 21.

As discussed above, the front-propagation implements a front-propagation algorithm that stores for each visited cell an indication of which cell is its immediate parent cell. Hence, any contact cell 22 may be traced back (by back-propagating along the front propagation paths) to both the source cell 20 and the target cell 21, thereby determining a first partial streamline between the source cell 20 and the contact cell 22 and a second partial streamline between the contact cell 22 and the target cell 21. The first partial streamline corresponds therefore to the list of successive visited cells along the front-propagation path between the source cell 20 and the considered contact cell 22. The second partial streamline corresponds to the list of successive visited cells along the front-propagation path between the target cell 21 and the considered contact cell 22.

As illustrated by FIG. 1, the streamline determination method 10 then comprises a step S106 of determining a streamline of the reservoir geological formation by combining the first and second partial streamlines originating from respectively the source cell 20 and the target cell 21 which reach the considered contact cell 22. Basically, the streamline is obtained by merging the first and second partial streamlines at the contact cell 22, thereby obtaining a list of successive visited cells from the source cell 20 to the target cell 21, one of the successive visited cells of the list being the considered contact cell 22.

Such streamlines may be determined for a plurality of contact cells 22 of the contact set 220, possibly for all contact cells 22 of the contact set 220. It is also possible to determine streamlines for only some of the contact cells 22 of the contact set 220. For instance it is possible to select a subset of all contact cells 22 of the contact set 220 based on a predetermined contact cell selection criterion. For instance, the contact cell selection criterion may correspond to selecting a predetermined number of the contact cells identified first during the front-propagations of the source front 200 and of the target front 210. Indeed, by iterating the front-propagations, the contact cells will be identified successively, and it is possible to determine streamlines only for the contact cells identified first. Equivalently, it is also possible to stop the front-propagations of the source front 200 and of the target front 210 once a predetermined number of contact cells have been identified.

Alternatively, it is possible to determine streamlines for each identified contact cell 22. It is then possible to keep all determined streamlines, or to keep only a subset of all determined streamlines based on a predetermined streamline selection criterion.

For instance, in some cases, the streamline determination method 10 may comprise determining an accessibility attribute value for each cell of the source front 200 and of the target front 210. The accessibility attribute may be any attribute that is representative of whether a visited cell is easy to access from the source cell 20 (resp. the target cell 21).

For instance, it is common, when using a fast marching algorithm, to compute times of flight (a.k.a. travel times) for the visited cells. A time of flight for a given visited cell is typically representative of the time needed to reach this considered visited cell from the source cell 20 (if the considered visited cell is on a front-propagation path originating from the source cell) or from the target cell 21 (if the considered visited cell is on a front-propagation path originating from the target cell). Hence, an example of accessibility attribute for a given visited cell is a time of flight from the source cell 20 (or the target cell 21 if the considered visited cell is on a front-propagation path originating from the target cell 21) to the considered visited cell. In such a case, a visited cell having a low time of flight value indicates that this visited cell is easy to access. For instance, the time of flight for a considered visited cell may be computed as a distance between the considered visited cell and its parent cell (e.g., distance between centers of the corresponding portions in the reservoir geological formation), multiplied by a slowness value, plus the time of flight of said parent cell (from the source cell 20 or the target cell 21). The slowness value may correspond to an inverse of the permeability of these cells (considered visited cell and its parent cell), e.g., a mean of the respective permeabilities of these cells (which may be included in the geological properties of a simulation grid). Of course, other expressions, considered known to the skilled person, may be used to compute time of flight values.

According to another example, if the reservoir grid corresponds to a 3D or 4D seismic image, then the accessibility attribute may correspond to a cumulated geophysical property (e.g., a cumulated seismic wave velocity change, a cumulated acoustic impedance, etc.). For instance, in the case of a 4D seismic image, then the 4D geophysical property value of a cell typically increases with the amount of fluid that was able to flow into the corresponding portion of the reservoir geological formation, and the amount of flow that was able to flow into a portion of the reservoir geological formation increases with the permeability of this portion. The cumulated 4D geophysical property value for a visited cell corresponds to the sum of the 4D geophysical property values of the considered visited cell, its parent cell, its grandfather cell, etc. up to the source cell 20 (or the target cell 21). In such a case, a visited cell having a high cumulated 4D geophysical property value indicates that this visited cell is easy to access.

Such accessibility attribute values may be computed during the front-propagations, during steps S101 and S102, but also when determining the partial streamlines, during steps S104 and S105. Indeed, a contact cell 22 belongs to front-propagation paths originating from both the source cell 20 and the target cell 21. Hence, it is possible to compute two accessibility attribute values for a contact cell 22, one relative to the source cell 20 and one relative to the target cell 21, which may be used to compute an accessibility attribute value for the target cell 21 relative to the source cell 20. Accordingly, it is possible to compute an accessibility attribute value for each streamline, representative of whether the target cell 21 is easy to access from the source cell 20 along the considered streamline. In a non-limitative example, the streamline selection criterion may correspond to selecting the streamlines along which the target cell 21 is most easily accessed from the source cell 20, according to the accessibility attributes values computed for the streamlines.

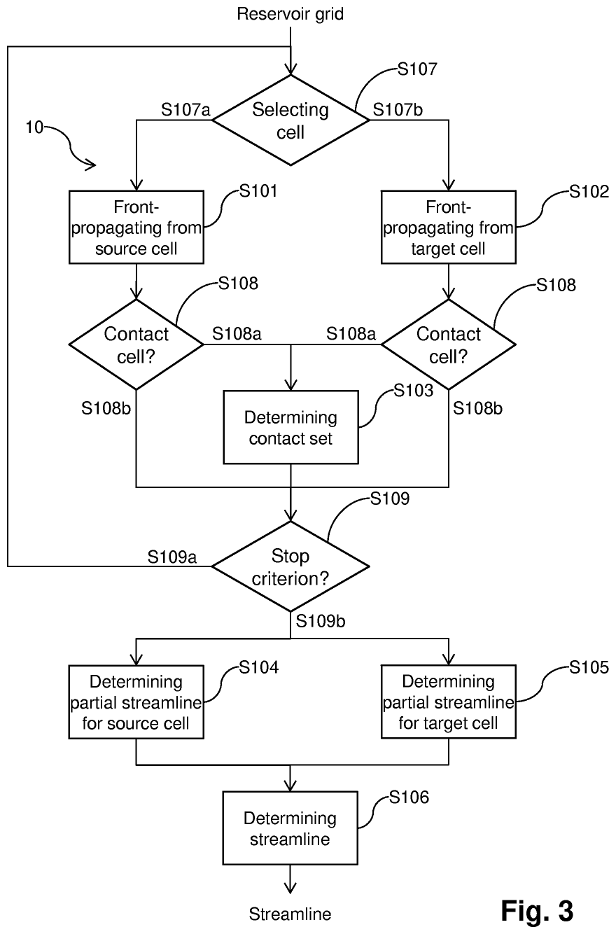

FIG. 3 represents schematically a preferred embodiment of the streamline determination method 10. As illustrated by FIG. 3, the step S101 of front-propagating from the source cell 20 and the step S102 of front-propagating from the target cell 21 are executed concurrently. In a conventional manner, these front-propagations are carried out iteratively, by iteratively propagating the source front 200 and the target front 210, respectively. In the example illustrated by FIG. 3, only one front is propagated at each iteration, either the source front 200 or the target front 210. We denote by “combined front” the set composed of all the cells that belong to either the source front 200 or the target front 210. In other words, the combined front corresponds to the combination of both the source front 200 and the target front 210. As illustrated by FIG. 3, the streamline determination method 10 comprises, at the beginning of an iteration, a step S107 of selecting one cell of the combined front according to a predetermined cell selection criterion. The selected cell may belong to either the source front 200 or to the target front 210. If the selected cell belongs to the source front 200 (reference S107a in FIG. 3), then only the source front 200 is propagated in the current iteration, for instance by front-propagating from at least the selected cell. In turn, if the selected cell belongs to the target front 210 (reference S107b in FIG. 3), then only the target front 210 is propagated in the current iteration, for instance by front-propagating at least from the selected cell. Front-propagating from the selected cell during the current iteration reaches one or more new visited cells which replace the selected cell, at least, in the combined front for the next iteration. Preferably, a cell that has been removed from a front (i.e., that has become a parent cell during the front-propagations) can no longer be reached from any other cell during the front-propagations. In other words, a cell that has been removed from a front during the front-propagations can no longer be included in a front (source front or target front) at a later stage of the front-propagations.

In some cases, if the streamline determination method 10 comprises computing accessibility attribute values for the visited cells, then the cell selection criterion may use the computed accessibility attribute values. For instance, the cell selection criterion may correspond to selecting the cell of the combined front that is, according to the determined accessibility attribute values, the easiest to access from the source cell 20 or the target cell 21. If the accessibility attribute corresponds to a time of flight, then the selected cell may correspond to the cell of the combined front that has the lowest time of flight value. If the accessibility attribute corresponds to a cumulated 4D geophysical property, then the selected cell may correspond to the cell of the combined front that has the greatest cumulated 4D geophysical property value, etc.

As illustrated by FIG. 3, at each iteration, the streamline determination method comprises a step S108 of evaluating whether the front-propagation of the considered front (i.e., the source front 200 or the target front 210) has reached the other front (i.e., the target front 210 or the source front 200, respectively). In other words, it is evaluated whether one of the cells visited from the selected cell belongs to the front that is not front-propagated during the current iteration. If the other front is reached (reference S108a in FIG. 3), then the step S103 of determining the contact set is executed, thereby labeling the corresponding cell as being a contact cell. It should be noted that a cell labeled as being a contact cell can no longer be used as selected cell during the next iterations (e.g., by removing the contact cell from the combined front considered during the selection step S107). In other words, no front-propagation is carried out from a cell labeled as contact cell. If the other front is not reached (reference S108b in FIG. 3), then the step S103 of determining the contact set is not executed.

In the non-limitative example illustrated by FIG. 3, the streamline determination method 10 comprises, for instance at each iteration, an optional step S109 of evaluating whether a front-propagation stopping criterion is verified. If the front-propagation stopping criterion is not verified (reference S109a in FIG. 3), then the streamline determination method 10 proceeds to the next iteration of the front-propagations, by executing the step S107 of selecting a cell of the combined front obtained the end of the previous iteration. If the front-propagation stopping criterion is verified (reference S109b in FIG. 3), then the front-propagations are stopped, and the streamline determination method 10 proceeds with the determination of the partial streamlines (steps S104 and S105) and the determination of the streamline (step S106) for any contact cell of interest.

As discussed above, such streamlines, computed much faster than in the prior art, can be used to improve the analysis and understanding of the reservoir geological formation. For instance, a human operator may use such streamlines to locate the drainage areas of each well, and therefore to locate areas in the reservoir geological formation which are not correctly drained by the wells (potentially triggering the decision of drilling other wells in the reservoir geological formation). Also, it is possible to consider one or more virtual targets, not associated to existing production wells but positioned at different candidate prospective positions for drilling a new production well, and to determine based on the computed streamlines the best position for drilling the new production well. Such streamlines may also be used to perform Assisted History Matching (AHM) to improve the accuracy of the simulation model, especially when the streamlines are computed based on a reservoir grid which corresponds to a 3D or 4D seismic image. Such streamlines may also be used to predict an amount of hydrocarbon that may be recovered from the reservoir geological formation by restricting, in a simulation model, the simulation grid to the cells composing said streamlines. Such streamlines may also be used to predict an amount of carbon dioxide that may be stored in the reservoir geological formation by restricting, in a simulation model, the simulation grid to the cells composing said streamlines.

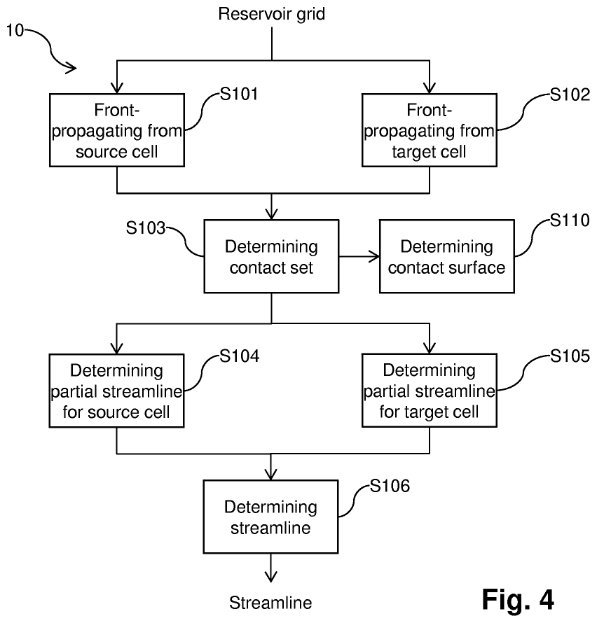

FIG. 4 represents schematically the main steps of another embodiment of the streamline determination method 10. In the embodiment illustrated by FIG. 4, the streamline determination method 10 comprises a step S110 of determining a contact surface based on the contact set.

Basically, the contact surface corresponds to a continuous surface approaching or interpolating the positions of the contact cells, and step S110 may use any algorithm known to the skilled person for generating such a continuous surface. For instance, step S110 may use any algorithm for generating a triangulated surface from a set of points (i.e., the positions of the contact cells). The contact surface may also be determined by polynomial regression of the positions of the contact cells, etc.

In some embodiments, the streamline determination method 10 may comprise evaluating a smoothness of the contact surface.

According to an example, the smoothness of the contact surface may be evaluated by applying a 2D frequency transform (e.g., a 2D Fourier transform, etc.) to the contact surface, thereby obtaining a frequency-domain contact surface. The smoothness may be evaluated by, e.g., analyzing the amplitude of mid/high frequency peaks of the frequency-domain contact surface. Typically, if the amplitude of the mid/high frequency peaks is low, then the contact surface tends to be smooth. In turn, if the amplitude of the mid/high frequency peaks is high, then the contact surface tends to be tortuous.

According to another non-limitative example, the smoothness of the contact surface may be evaluated by comparing the contact surface with a reference surface. Basically, the reference surface corresponds to a smooth surface which approximates the contact surface. For instance, the reference surface is determined based on the respective positions of the contact cells, e.g., by approaching said positions. For instance, the reference surface may be obtained by polynomial regression of said positions (using a lower order than for the contact surface if the contact surface is also determined by polynomial regression), by spline regression, etc., or by low-pass filtering the contact surface. For instance, the smoothness of the contact surface can be evaluated by computing differences between the contact surface and the reference surface for a plurality of points of the contact surface. For instance, the smoothness of the contact surface may be evaluated by analyzing the variance of the computed differences. Typically, if the variance of is low, then the contact surface tends to be smooth. In turn, if the variance is high, then the contact surface tends to be tortuous.

The smoothness/tortuosity of the contact surface can be used to evaluate the homogeneity/heterogeneity of the geological/geophysical property values included in the reservoir grid. For instance, a smooth contact surface is indicative of homogeneous geological/geophysical property values, while a tortuous contact surface is indicative of heterogeneous geological/geophysical property values in the reservoir geological formation. Such homogeneous/heterogeneous information may be used to, e.g., to detect the presence of a fault in the reservoir geological formation.

Alternatively or in combination thereof, each cell of the contact surface may have an accessibility attribute value (e.g., a time of flight value) associated thereto. The distribution of these accessibility attribute values on the contact surface gives meaningful information on the distribution of the streamlines, which may be used for fluid flow simulations.

Also, the contact surface should in principle be orthogonal to the streamlines. Alternatively or in combination thereof, the contact surface may therefore be used to evaluate the directions of the streamlines.

It is emphasized that the present disclosure is not limited to the above exemplary embodiments. Variants of the above exemplary embodiments are also within the scope of the present disclosure.

For instance, the streamline determination method 10 has been disclosed by considering mainly a single source cell 20 and a single target cell 21. Of course, and as discussed hereinabove, the streamline determination method 10 can also be applied with more than one source cell 20 per source in the reservoir geological formation and/or more than one target cell 21 per target in the reservoir geological formation. Also, the streamline determination method 10 may be applied similarly with more than one source (e.g., a plurality of injection wells) and/or more than one target (e.g., a plurality of production wells) in the reservoir geological formation.

Also, the present disclosure has been given by considering mainly the case where streamlines are determined. However, as discussed above, the contact set determined by front-propagating concurrently from both a source cell 20 and a target cell 21 may also be used to determine a contact surface which may be used for further analysis of the reservoir geological formation. Hence, the determined contact set may be used to determine streamlines and/or to determine a contact surface. In other words, the present disclosure also covers a method for analyzing the reservoir geological formation which comprises determining a contact set as discussed above, but does not comprise any determination of streamlines, the contact set being used to determine a contact surface, for instance in order to evaluate the homogeneity/heterogeneity of the geological/geophysical property values of the reservoir grid (by, e.g., evaluating the smoothness of said contact surface).

The above description clearly illustrates that by its various features and their respective advantages, the present disclosure reaches the goals set for it, since it enables to determine a contact set which may be used to determine streamlines between a source and a target in a reservoir geological formation and/or to determine a contact surface which may be used for further analysis of the reservoir geological formation.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer implemented method for determining streamlines between a source and a target in a reservoir geological formation, based on a reservoir grid corresponding to a 3D grid of cells wherein each cell represents a respective portion of the reservoir geological formation, wherein said method comprises:
front-propagating from a source cell of the reservoir grid, which corresponds to the source in the reservoir geological formation, to determine front propagation paths originating from the source cell,
front-propagating from a target cell of the reservoir grid, which corresponds to the target in the reservoir geological formation, to determine front propagation paths originating from the target cell, and
determining a contact set which is composed of contact cells of the reservoir grid at which the front propagation paths originating from the source cell meet the front propagation paths originating from the target cell,
and, for at least one contact cell of the contact set:
determining a partial streamline by back-propagating along the front-propagation paths originating from the source cell, from said at least one contact cell up to the source cell,
determining a partial streamline by back-propagating along the front-propagation paths originating from the target cell, from said at least one contact cell up to the target cell, and
determining a streamline of the reservoir geological formation by combining the partial streamlines originating from respectively the source cell and the target cell which reach said at least one contact cell.

2. The computer implemented method according to claim 1, wherein the front-propagating from the source cell and the front-propagating from the target cell are performed by iteratively propagating a source front and a target front, respectively, wherein each iteration comprises propagating only one among the source front and the target front, by:
selecting one cell among the cells of the source front and the cells of the target front, and
propagating only the front, among the source front and the target front, which comprises the selected cell.

3. The computer implemented method according to claim 2, comprising determining an accessibility attribute value for each cell of the source front and of the target front, and wherein the selected cell corresponds to the cell that is, according to the determined accessibility attribute values, the easiest to access from the source cell and the target cell.

4. The computer implemented method according to claim 3, wherein the accessibility attribute corresponds to a time of flight.

5. The computer implemented method according to claim 3, wherein the accessibility attribute corresponds to a cumulated geophysical property.

6. The computer implemented method according to claim 2, wherein a contact cell corresponds to a cell, of one among the source front and the target front, that is reached when front-propagating from a selected cell of the other one among the source front and the target front.

7. The computer implemented method according to claim 1, wherein front-propagating is performed by using a fast marching algorithm.

8. The computer implemented method according to claim 1, comprising determining a contact surface based on the contact set.

9. The computer implemented method according to claim 8, comprising evaluating a smoothness of the contact surface.

10. The computer implemented method according to claim 9, wherein the smoothness of the contact surface is evaluated by comparing said contact surface with a reference surface.

11. The computer implemented method according to claim 10, wherein the reference surface is determined based on positions of the contact cells.

12. The computer implemented method according to claim 9, wherein the smoothness of the contact surface is evaluated by applying a frequency transform to the contact surface, thereby obtaining a frequency-domain contact surface, and by analyzing the frequency-domain contact surface.

13. A computer program product stored on a non-transitory computer-readable medium comprising instructions which, when executed by at least one processor, configure said at least one processor to carry out the streamline determination method according to claim 1.

14. A non-transitory computer-readable storage medium comprising instructions which, when executed by at least one processor, configure said at least one processor to carry out the streamline determination method according to claim 1.

15. A computer system for analyzing a reservoir geological formation by using a reservoir grid, said computer system comprising at least one processor and at least one memory, said at least one processor being configured to carry out the streamline determination method according to claim 1.

16. The computer implemented method according to claim 1, wherein:
the source is an injection well in the reservoir geological formation; and
the target is a production well in the reservoir geological formation, the method further comprising:
determining a connectivity and/or heterogeneity of the reservoir geological formation between the injection well and the production well according to the streamline; and
recovering hydrocarbons from the reservoir geological formation based on the determined connectivity and/or heterogeneity.

17. The computer implemented method according to claim 1, wherein:
the source is an injection well in the reservoir geological formation; and
the target is a production well in the reservoir geological formation,
the method further comprising:
determining a contact surface of the reservoir geological formation based on the contact set; and
recovering hydrocarbons from the reservoir geological formation in accordance with a smoothness of the contact surface, wherein the smoothness of the contact surface is obtained by comparing the contact surface with a reference surface.

18. The computer implemented method according to claim 1, wherein:
the source is an injection well in the reservoir geological formation; and
the target is a production well in the reservoir geological formation,
the method further comprising:
determining a contact surface of the reservoir geological formation based on the contact set; and
recovering hydrocarbons from the reservoir geological formation in accordance with a smoothness of the contact surface, wherein the smoothness of the contact surface is obtained by applying a frequency transform to the contact surface, thereby obtaining a frequency-domain contact surface, and by analyzing the frequency-domain contact surface.
